(19) United States
(12) Patent Application Publication
(10) Pub. No.: US 2024/0403464 A1
(43) Pub. Date: Dec. 5, 2024

(54) AUTHENTICATED DATA ACCESS USING MASKED CREDENTIAL DATA

(71) Applicant: State Farm Mutual Automobile Insurance Company, Bloomington, IL (US)

(72) Inventors: Satya Ravinuthala, Normal, IL (US); Suresh Kumar Alluri, Secunderabad (IN)

(73) Assignee: State Farm Mutual Automobile Insurance Company, Bloomington, IL (US)

(21) Appl. No.: 18/327,701

(22) Filed: Jun. 1, 2023

(51) Int. Cl. G06F 21/62; H04L 9/40

(52) U.S. Cl. CPC G06F 21/6218; H04L 63/08

(57) ABSTRACT

Techniques for authenticated data retrieval and/or storage using masked credential data are described. In accordance with some of the techniques described herein, a method includes receiving a data retrieval request associated with accessing target data stored on a cloud storage platform; providing a credential data request associated with the data retrieval request and the cloud storage platform to a credential data management server; based on the credential data request, receiving credential data from the credential data management server; determining a field of a data retrieval script based on the credential data; and executing the data retrieval script based on the field, wherein executing the data retrieval script includes establishing an authenticated connection with the cloud storage platform and accessing the target data using the authenticated connection.

### TECHNICAL FIELD

The present disclosure relates to data security applications, and more particularly to establishing an authenticated connection using credential data.

### BACKGROUND

In some cases, data security requirements associated with an application system may require that, when a user uses the application system to access a storage platform based on credential data associated with the application system, the credential data is masked such that the user does not have direct access to the credential data and does not know what the credential data entails. For example, in an environment in which credential data is shared across an organization and/or company, if a user is granted user-level access privileges to use an application server that establishes an authenticated connection with a target data storage platform, then the user may have direct access to the credential data absent data security precautions.

Enabling data retrieval or storage using masked credential data becomes specially challenging when the user that requests data retrieval and/or storage is granted user-level (as opposed to administrator-level) access to an application server. The reason this problem is challenging is that, while masking credential data is important for various data security protocols and applications, enabling user-level access to an application server can expose data used, retrieved, and/or stored by the application server to the user. Therefore, there exists a need for a solution that enables a user who has user-level access to an application server to use the application server to retrieve and/or store data using authenticated connections that are established based on masked credential data.

Examples of the techniques described in the present disclosure are directed to overcoming the deficiencies noted above.

### SUMMARY

In some aspects, the techniques described herein relate to a computer-implemented method, including: receiving, by a processor of an application server and from a client device, a data retrieval request associated with accessing target data stored on a cloud storage platform; providing, by the processor, a credential data request associated with the data retrieval request and the cloud storage platform to a credential data management server; based on the credential data request, receiving, by the processor, credential data from the credential data management server; storing, by the processor, the credential data in a field of a data retrieval script; and executing, by the processor, the data retrieval script based on the field, wherein executing the data retrieval script includes establishing an authenticated connection with the cloud storage platform and accessing the target data using the authenticated connection.

In additional examples, the techniques described herein relate to a computing system, including: a processor; and memory storing computer-executable instructions that, when executed by the processor, cause the computing system to perform operations including: receiving, by the processor of an application server and from a client device, a data retrieval request associated with accessing target data stored on a cloud storage platform; providing, by the processor, a credential data request associated with the data retrieval request and the cloud storage platform to a credential data management server; based on the credential data request, receiving, by the processor, credential data from the credential data management server; storing, by the processor, the credential data in a field of a data retrieval script; and executing, by the processor, the data retrieval script based on the field, wherein executing the data retrieval script includes establishing an authenticated connection with the cloud storage platform and accessing the target data using the authenticated connection.

In further examples, the techniques described herein relate to one or more non-transitory computer-readable media storing computer-executable instructions that, when executed by the processor, cause the one or more processors to perform operations, including: receiving, by the processor of an application server and from a client device, a data retrieval request associated with accessing target data stored on a cloud storage platform; providing, by the processor, a credential data request associated with the data retrieval request and the cloud storage platform to a credential data management server; based on the credential data request, receiving, by the processor, credential data from the credential data management server; storing, by the processor, the credential data in a field of a data retrieval script; and executing, by the processor, the data retrieval script based on the field, wherein executing the data retrieval script includes establishing an authenticated connection with the cloud storage platform and accessing the target data using the authenticated connection.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 provides an example architecture for authenticated data retrieval and/or storage with masked credential data.

FIG. 2 is a flowchart diagram of an example process for performing an authenticated data retrieval and/or storage.

FIG. 3 provides an operational example of a structure for an example data retrieval script.

FIG. 4 provides an operational example of a structure for an example data storage script.

FIG. 5 provides an operational example of a process for executing a data retrieval script or a data storage script.

FIG. 6 provides an operational example of an organizational structure for a credential data management server.

FIG. 7 shows an example system architecture for a computing device associated with the architecture described herein.

### DETAILED DESCRIPTION

This disclosure describes techniques for authenticated data retrieval and/or storage using an authenticated connection that is established using masked credential data while the user that requests data retrieval and/or storage is granted user-level (as opposed to administrator-level) access to an application server. The techniques described herein enable data retrieval and/or data storage based on a user request and using an authenticated connection that is established between an application server giving user-level access privileges to the user and a data storage platform. In some cases, the authenticated connection is established using masked credential data.

To enable data retrieval and/or storage using masked credential data while granting user-level access to the requesting user, the techniques described herein utilize at least one of the following techniques: (i) storing credential data in a credential data management server that is separate from an application server used to connect to a data storage platform, (ii) executing a data retrieval script or a data storage script using a root process of the application server that is not accessible by a user that is given user-level access to the application server, and (iii) storing credential data retrieved from a credential data management server as a local variable of a data retrieval script or a data storage script.

In accordance with some of the techniques described herein, a credential data management server enables storing and retrieving credential data (e.g., one or more credential tokens) associated with an application system that includes an application server. In some cases, the credential data management server that is associated with an application system is separate from the application server that is in the application system. In some cases, because credential data associated with an application system are stored not on the application server in the application system but on a credential data management server that is separate from the application system, a user having user-level access privileges to the application server will not have direct access to the credential data on a permanent basis, as transmission of credential data to the application server requires a request to the credential data management server. Storing credential data on a credential data management server that is separate from an application server on which a user of the application system has user-level access privileges provides a first layer of protection against direct access to the credential data by unauthorized users (e.g., by non-administrator users of the application server that do not have access to a root process of the application server).

In accordance with some of the techniques described herein, the credential data management server is configured to provide credential data only based on (e.g., in response to) a request that is contained within a data retrieval or storage script that is executed by a root process of an application server. Accordingly, to retrieve credential data needed for accessing a storage platform from a credential data management server, a user of the application server needs to cause execution of a data retrieval or storage script by a root process of an application server. For example, the user can use a non-root process to request that the root process executes a data retrieval or storage script. Requiring that a successful request for retrieval of credential data is provided using a data retrieval or storage script that is executed by a root process of the application server provides a second layer of protection against direct access to the credential data by unauthorized users (e.g., by non-administrator users of the application server that do not have access to a root process of the application server).

In accordance with some of the techniques described herein, after a data retrieval or storage script retrieves credential data needed for establishing an authenticated connection to a data storage platform, the data retrieval or storage script stores the credential data using a local variable of the script that is not accessible outside of the script. Without having access to a root process of the application server that executes the data retrieval or storage script and/or without having access to the data stored in a local variable of the script during an execution of the script by the root process, a user having user-level access privileges to an application server cannot directly access the credential data.

Accordingly, the techniques described herein enable establishing an authenticated connection between an application server and a data storage platform using masked credential data that is not directly accessible by a user having user-level access privileges to the application system. Storing credential data retrieved using a data retrieval or storage script in a local variable of the script provides a third layer of protection against direct access to the credential data by unauthorized users (e.g., by non-administrator users of the application server that do not have access to a root process of the application server).

Thus, the techniques described herein enable one or more layers of protection against direct access to the credential data by unauthorized users (e.g., by non-administrator users of the application server that do not have access to a root process of the application server). The techniques described herein enhance the data security of an application server that is used to retrieve data from a data storage platform and/or store data on a data storage platform. Additionally, the techniques described herein enable data retrieval and/or data storage based on a user request and using an authenticated connection that is established between an application server giving user-level access privileges to the user and a data storage platform. In some cases, the authenticated connection is established using masked credential data.

For example, the techniques described herein include at least one of the following operations: receiving, by a processor of an application server and from a client device, a data retrieval request associated with accessing target data stored on a cloud storage platform; providing, by the processor, a credential data request associated with the data retrieval request and the cloud storage platform to a credential data management server; based on the credential data request, receiving, by the processor, credential data from the credential data management server; determining, by the processor, a field of a data retrieval script based on the credential data; or executing, by the processor, the data retrieval script based on the field, wherein executing the data retrieval script includes establishing an authenticated connection with the cloud storage platform and accessing the target data using the authenticated connection.

As another example, the techniques described herein include at least one of the following operations: receiving, by a processor and from a client device, a data storage request associated with storing target data in a local storage platform, wherein the local storage platform includes a component of an application system and the application system also includes the application server; providing, by the processor, a credential data request associated with the data storage request and the local storage platform to a credential data management server; based on the credential data request, receiving, by the processor, credential data from the credential data management server; determining, by the processor, a field of a data storage script based on the additional credential data; and executing, by the processor, the data storage script based on the field of the data storage script, wherein executing the data storage script includes establishing an additional authenticated connection with the local storage platform and storing the target data using the additional authenticated connection.

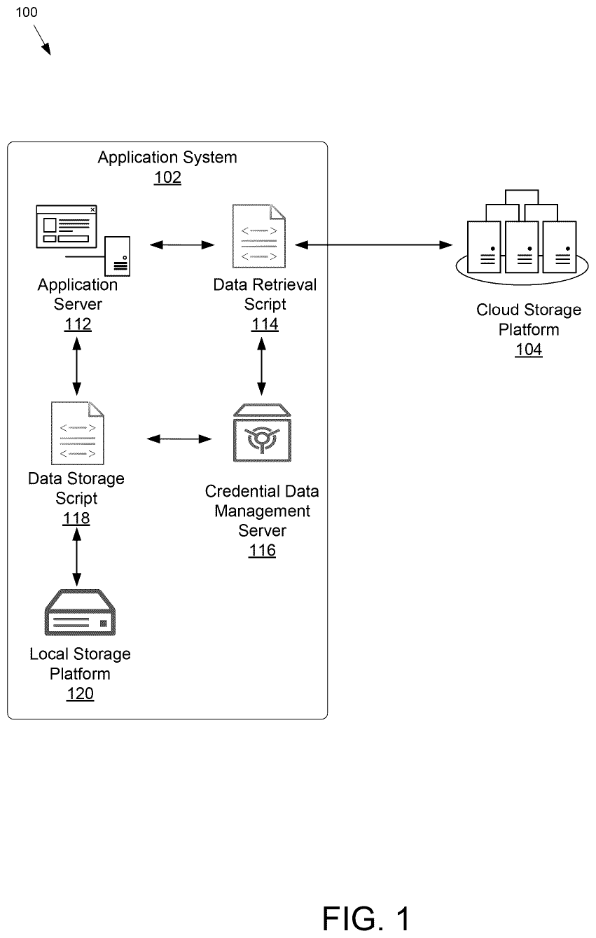

FIG. 1 provides an example architecture 100 for authenticated data retrieval and/or storage with masked credential data. As depicted in FIG. 1, the architecture 100 includes an application system 102 and a cloud storage platform 104.

The cloud storage platform 104 may be a data storage platform that is remote from the application system 102, such that accessing the cloud storage platform 104 using the application system 102 requires establishment of a networked connection (e.g., a public internet connection or a dedicated private network connection) between the application system 102 and the cloud storage platform 104. Examples of cloud storage platforms include the Amazon® Web Services (AWS) platform, the Microsoft® Azure platform, the Google® Cloud platform, and/or the like.

The application system 102 may enable retrieval of data from a data storage platform and/or storage of data on a data storage platform based on a data retrieval request and/or a data storage request provided by a user (e.g., a user of the application system 102 and/or a user of a client system that is connected to the application system 102 via a networked connection).

For example, the application system 102 may enable retrieval of data from the cloud storage platform 104 and storage of the retrieved data on a local storage platform 120 of the application system 102. As another example, the application system 102 may enable retrieval of data from the local storage platform 120 and storage of the retrieved data on the cloud storage platform 104. As a further example, the application system 102 may enable storage of data retrieved from at least one of the local storage platform 120 or the cloud storage platform 104 on a client system that is used by a requesting user. As an additional example, the application system may enable storage of data retrieved from a client system that is used by a requesting user on at least one of the local storage platform 120 or the cloud storage platform 104.

In some cases, accessing a data storage platform (e.g., the cloud storage platform 104 or the local storage platform 120) using the application system 102 requires using credential data associated with the application system 102. For example, to access the cloud storage platform 104 using the application system 102, a requesting user may need to establish an authenticated connection between the application system 102 and the cloud storage platform 104 using credential data associated with the application system 102. As another example, to access the local storage platform 120 using the application system 102, a requesting user may need to cause the application system 102 to provide credential data associated with the application system 102 to the local storage platform 120.

In some cases, data security requirements associated with the application system 102 may require that, when a user uses the application system 102 to access a storage platform based on credential data associated with the application system 102, the credential data is masked such that the user does not have direct access to the credential data and does not know what the credential data entails. For example, if the credential data include an authentication token, the data security requirements associated with the application system 102 may require that, while a user can cause the application system 102 to access a storage platform based on the authentication token, the application system 102 does not display the authentication token to the user.

In some cases, the application system 102 may be enable a group of users (e.g., a group of users associated with an organization and/or a company) to access a target storage platform based on credential data that is shared among the group. In some cases, when credential data needed for accessing a storage platform is shared among a group of users, the data security requirements associated with the application system 102 may require that, when a user in the group uses the application system 102 to access a storage platform based on the shared credential data, the user does not have direct access to the credential data and does not know what the credential data entails. Accordingly, the application system 102 uses techniques for enabling authenticated data retrieval and/or storage using masked credential to enable compliance with one or more data security requirements associated with the application system.

As depicted in FIG. 1, the application system 102 includes an application server 112, a credential data management server 116, and a local storage platform 120. While the example architecture 100 of FIG. 1 can be used to retrieve data from the cloud storage platform 104 and store data (e.g., the data retrieved from the cloud storage platform 104) on the local storage platform 120, a person of ordinary skill in the relevant technology will recognize that the application system 102 can retrieve data from either or both of the cloud storage platform 104 and the local storage platform 120. Moreover, a person of ordinary skill in the relevant technology will recognize that the application system 102 can store data on either or both of the cloud storage platform 104 and the local storage platform 120.

The application server 112 may enable a user to gain user-level access to at least one process associated with an operating system of the application server 112. For example, the application server 112 may be a Linux server that enables a user to gain user-level access to non-root processes associated with a Linux operating system executing on the application server 112.

In some cases, a user is authorized to gain user-level access to a set of processes of the application server 112 as determined based on a set of access parameters associated with the user. For example, the operating system of the application server 112 may enable the user to log in using an access profile that is associated with a set of access parameters, such as an access parameter representing that a user logged into the access profile is authorized to access first data associated with a first process in a read-only mode or an access parameter representing that a user logged into the access profile is authorized to access second data associated with a second process in a read-or-write mode.

In some cases, the access parameters of an access profile represent that a user logged into the access profile is authorized to execute operations associated with a first set of operating system processes of the application server 112 and/or is not authorized to access operations associated with a second set of operating system processes of the application server 112. For example, the access parameters associated with an administrative access profile may represent that an administrator user who is logged into the administrative access profile is authorized to execute operations corresponding to all of the operating system processes of the application server 112. As another example, the access parameters associated with a non-administrative access profile may represent that a non-administrator user who is logged into the non-administrative access profile is authorized to execute operations corresponding to all of the non-root operating system processes of the application server 112.

In some cases, an administrator user associated with an administrative access profile is granted administrator-level access to the application server 112 which enables the administrator user to access all processes executed by the application server 112, including the root process of the application server 112. In some cases, a non-administrator user associated with a non-administrative access profile is granted user-level access to the application server 112 which enables the administrator user to access all processes executed by the application server 112 other than the root process of the application server 112.

As described above, the application system 102 uses techniques for enabling authenticated data retrieval and/or storage based on masked credential to enable compliance with the data security requirements associated with the application system 102. The noted techniques enable authenticated data retrieval and/or storage using masked credential data even when the credential data is stored by an application server 112 to which a user has user-level access privileges. The requirement of masking the credential data stored on an application server 112 to prevent a user who has gained user-level access to the application server 112 presents unique technical challenges that are addressed by the techniques described herein.

The local storage platform 120 may be a storage platform that is not remote to the application system 102 and enables a user of the application system 102 to store and/or retrieve data. The application server 112 may enable a user to perform operations that are configured to retrieve data from and/or store data on the local storage platform. An example of a local storage platform 120 is a locally-stored file hosting platform, such as a locally-stored Microsoft® OneDrive platform.

Additionally, the application server 112 may enable a user to perform operations that are configured to retrieve data from and/or store data on a storage platform (e.g., the cloud storage platform 104 or the local storage platform 120). To enable data retrieval from and/or data storage on a storage platform, the application server 112 enables the user to cause execution of a data retrieval script and/or a data storage script.

A data retrieval script may be configured to establish an authenticated connection with a storage platform and retrieve target data using the established connection. For example, as depicted in FIG. 1, the data retrieval script 114 enables retrieval of data from the cloud storage platform 104. In accordance with some of the techniques described herein, a data retrieval script establishes an authenticated connection using credential data that is stored as a field (e.g., a local variable) of the data retrieval request. Subsequent to establishing the authenticated connection, the data retrieval script uses the authenticated connection to retrieve the target data on the target storage platform. Moreover, subsequent to retrieving the target data, the data retrieval script terminates the authenticated connection.

In accordance with some of the techniques described herein, a data retrieval script is executed by a root process of the application server 112. In some cases, a data retrieval script is executed by a non-root process of the application server 112. In some cases, the authenticated connection established by a data retrieval request is established using a Secure Shell File Transfer Protocol (SFTP) protocol. In some cases, establishing the additional authenticated connection includes providing a field of the data retrieval script (e.g., a field that stores credential data) using a bypass mechanism for a keyboard inactivity requirement of the STFP protocol. In some cases, the bypass mechanism is an SSHPASS mechanism.

A data storage script may be configured to establish an authenticated connection with a storage platform and store target data using the established connection. For example, as also depicted in FIG. 1, the data storage script 118 enables storage of data (e.g., storage of data retrieved using the data retrieval script 114) on the local storage platform. In accordance with some of the techniques described herein, a data storage script establishes an authenticated connection using credential data that is stored as a field (e.g., a local variable) of the data storage request. Subsequent to establishing the authenticated connection, the data storage script uses the authenticated connection to store the target data on the target storage platform. Moreover, subsequent to storage the target data, the data storage script terminates the authenticated connection.

In some cases, a data storage script is executed by a root process of the application server 112. In some cases, a data storage script is executed by a non-root process of the application server 112. In some cases, the authenticated connection established by a data storage request is established using an SFTP protocol. In some cases, establishing the additional authenticated connection includes providing a field of the data storage script (e.g., a field that stores credential data) using a bypass mechanism for a keyboard inactivity requirement of the STFP protocol. In some cases, the bypass mechanism is an SSHPASS mechanism.

In accordance with some of the techniques described herein, to enable data retrieval or storage using an authenticated connection, a data retrieval script or a data storage script retrieves credential data from the credential data management server 116 and uses the retrieved credential data as part of a request to retrieve data and/or store data. For example, the data retrieval script 114 of FIG. 1 may retrieve credential data from the credential data management server 116, use the retrieved credential data to establish an authenticated connection with the cloud storage platform 104, and use the established connection to retrieve data from the cloud storage platform 104. As another example, the data storage script 118 of FIG. 1 may retrieve credential data from the credential data management server 116, use the retrieved credential data to establish an authenticated connection with the local storage platform 120, and use the established connection to store data on the local storage platform 120.

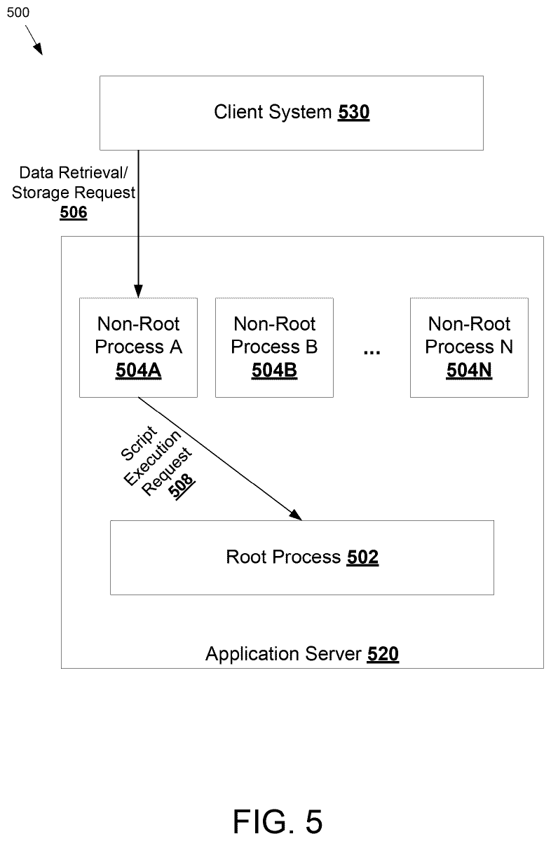

In accordance with some of the techniques described herein, the data access script and/or the data storage script 118 are executed based on a request by a non-administrator user of the application server 112 who is logged into a non-administrative access profile of the application server 112 and/or granted user-level access to the application server 112. Exemplary techniques for executing data retrieval requests and/or data storage requests are described in greater detail below with reference to FIG. 5.

The credential data management server 116 may enable storing and retrieving credential data (e.g., one or more credential tokens) associated with the application system 102. In accordance with some of the techniques described herein, the credential data management server 116 enables controlled access to one or more credential tokens (e.g., passwords, secrets, encryption keys, and/or the like) by authenticating a request for a credential token against one or more trusted sources of identity such as identity sources provided using the Lightweight Directory Access Protocol (LADP). An example of the credential data management server 116 is a HashiCorp Vault server.

While the exemplary architecture 100 of FIG. 1 depicts the credential data management server 116 as being part of the application system 102, a person of ordinary skill in the relevant technology will recognize that the credential data management server 116 could be outside of the application system. For example, the credential data management server 116 may be remote from the application system 102. In some cases, the application server 112 of the application system 102 and the credential data management server 116 are connected using an external network connection.

In some cases, the credential data management server 116 is configured to provide credential data based on (e.g., in response to) a request that is contained within a data retrieval script 114 or a data storage script 118 that is executed by a root process of the application server 112. Accordingly, to retrieve credential data needed for accessing a storage platform from the credential data management server 116, a user of the application server 112 needs to cause execution of a data retrieval script 114 or a data storage script 118 by a root process of an application server. For example, the user can use a non-root process to request that the root process executes a data retrieval script 114 or a data storage script 118. In some cases, requiring that a successful request for retrieval of credential data is provided using a data retrieval or storage script that is executed by a root process of the application server 112 provides a layer of protection against direct access to the credential data by unauthorized users (e.g., by non-administrator users of the application server 112 that do not have access to a root process of the application server).

In some cases, the credential data management server 116 may determine the credential data provided in response to a request for credential data based on at least one of a client identifier associated with the request, an application identifier associated with the request, or a target storage platform associated with the request. In some cases, the credential data management server 116 is configured to retrieve the credential data based on an application identifier associated with the non-root process. In some cases, the credential data management server 116 is configured to retrieve the credential data based on a client identifier associated with the data retrieval request.

For example, the credential data management server 116 may provide first credential data in response to a first request associated with a first script executed by a first client (e.g., a first user, a first company, a first customer, and/or the like), where the execution of the first script is caused by a first user-provided command provided using a first application, and where the first script is configured to retrieve data and/or store data on a first storage platform. As another example, the credential data management server 116 may provide second credential data in response to a second request associated with a second script executed by a second client (e.g., a second user, a second company, a second customer, and/or the like), where the execution of the second script is caused by a second user-provided command provided using a second application, and where the second script is configured to retrieve data and/or store data on a second storage platform.

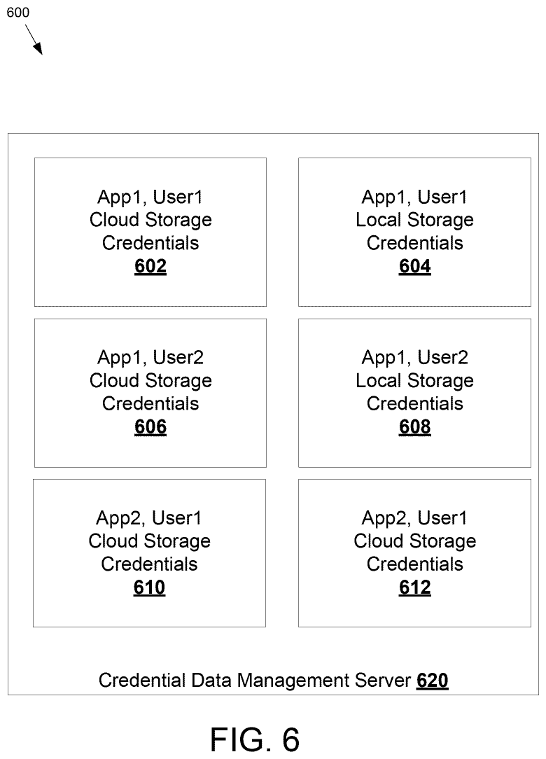

Accordingly, different client identifiers, different application identifiers, different target storage platforms, or different combination of two or more of the noted features are associated with different credential data. Exemplary organizational schemes for credential data management servers are described in greater detail below with reference to FIG. 6.

Thus, the data access script 114 and the data storage script 118 enable authenticated data retrieval and/or storage using an authenticated connection that is established using masked credential data while the user that requests data retrieval and/or storage is granted user-level (as opposed to administrator-level) access to an application server

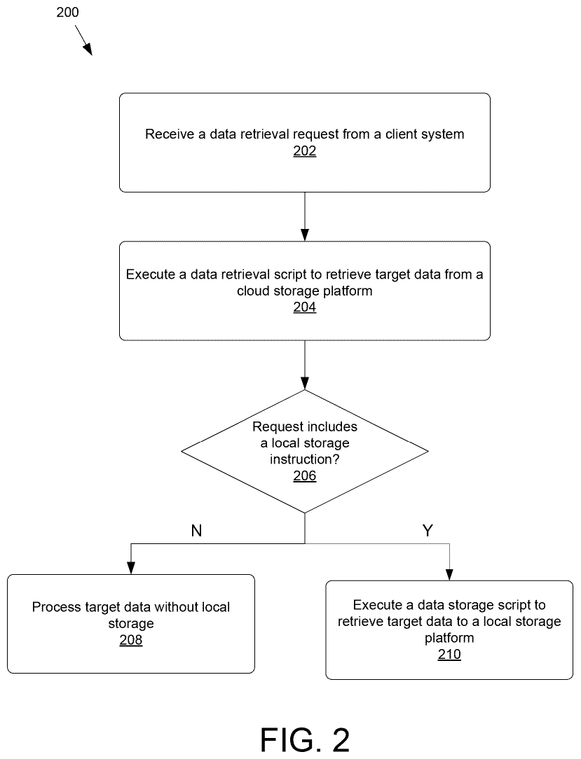

FIG. 2 is a flowchart diagram of an example process 200 for performing an authenticated data retrieval and/or storage. The steps of the process 200 may be performed by any of the processors described herein. However, for discussion purposes, the steps of the process 200 are described as being performed by the application server 112.

At block 202, the application server 112 retrieves a data retrieval request from a client system (e.g., a system used by a user who is granted user-level access to the application server 112). The data retrieval request may represent a request to retrieve target data from the cloud storage platform 104. For example, the data retrieval request may be a request to query a database that is stored on the cloud storage platform 104.

In some cases, the data retrieval request is generated based on a user execution of a non-root process of the application server 112. In some cases, execution of the non-root process causes providing a request to a root process of the application server 112 to execute the data retrieval script 114.

Although the example process 200 of FIG. 2 is described with reference to data retrieval script 114 and data storage script 118 of FIG. 1, a person of ordinary skill in the relevant technology will recognize that the techniques of process 200 can be performed to enable authenticated data retrieval and/or storage using other data retrieval scripts and/or other data storage scripts. For example, the techniques of process 200 can be performed to enable authenticated data retrieval and/or storage using a data retrieval script that is configured to retrieve data from a local storage platform (e.g., the local storage platform 120 of FIG. 1). As another example, the techniques of process 200 can be performed to enable authenticated data retrieval and/or storage using a data retrieval script that is configured to store data on a cloud storage platform (e.g., the cloud storage platform 104 of FIG. 1).

At block 204, the application server 112 executes the data retrieval script 114 to retrieve the target data from the cloud storage platform 104. The data retrieval script 114 may be a computer-implemented routine that is configured to retrieve credential data from the credential data management server 116, use the retrieved credential data to establish an authenticated connection to the cloud storage platform 104, and use the authenticated connection to retrieve target data from the cloud storage platform 104.

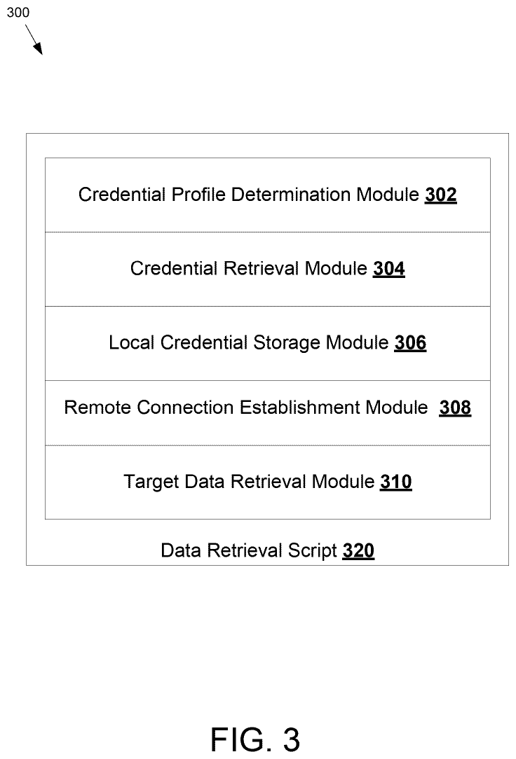

To use the retrieved credential data to establish the authenticated connection to the cloud storage platform, the data retrieval script 114 stores the retrieved credential data as a local variable of the data retrieval script 114 that is not provided to any process except for the process that is executing the data retrieval script 114. In some cases, the data retrieval script is executed by a root process of the application server 112. Exemplary structures for a data retrieval script 114 and exemplary techniques for executing a data retrieval script 114 are described in greater detail below with reference to FIGS. 3 and 5 respectively.

In accordance with some of the techniques described herein, the data retrieval script is executed by a root process of the application server. In some cases, the data retrieval script is executed by a non-root process of the application server. The data retrieval script includes the credential data retrieved from the credential data management server. For example, a field of the data retrieval script is determined based on the credential data. In some cases, the field is a local variable of the data retrieval script. In some cases, the credential data management server is configured to retrieve the credential data based on one or more application identifiers associated with the non-root process. In some cases, the credential data management server is configured to retrieve the credential data based on one or more client identifiers associated with the data retrieval request.

At block 206, the application server 112 determines whether the data retrieval request received at block 202 includes an instruction to store the target data on the local storage platform 120. In some cases, the data retrieval request has a flag field that, if set to an affirmative value (e.g., a value of one or true), indicates that the user requests storage of the target data retrieved from the cloud storage platform 104 on the local storage platform 120. In some cases, if the flag field is set to a negative value (e.g., a value of zero or false), this indicates that the user does not request storage of the target data retrieved from the cloud storage platform 104 on the local storage platform 120.

At block 208, the application server 112 processes the target data without storage of the target data on the local storage platform 120 based on (e.g., in response to) determining that the data retrieval request does not include an instruction to store the target data on the local storage platform 120. For example, if the application server 112 determines that the data retrieval request does not include an instruction to store the target data on the local storage platform 120, the application server 112 stores the target data on a random access memory of the application server 112, uses the target data to perform one or more real-time data processing operations, and subsequently discards the target data by deleting the target data from the random access memory.

At block 210, the application server 112 executes the data storage script 118 to store the target data on the local storage platform 120 based on (e.g., in response to) determining that the data retrieval request includes an instruction to store the target data on the local storage platform 120. The data storage script 118 may be a computer-implemented routine that is configured to retrieve credential data from the credential data management server 116, use the retrieved credential data to establish an authenticated connection to the local storage platform 120, and use the authenticated connection to store target data on the local storage platform 120.

In accordance with some of the techniques described herein, the data storage script 118 is executed by a root process of the application server 112. In some cases, the data storage script 118 is executed by a non-root process of the application server 112. In some cases, the authenticated connection established by the data storage script 118 is established using an SFTP protocol. In some cases, establishing the additional authenticated connection includes providing a field of the data storage script (e.g., a field that stores credential data) using a bypass mechanism for a keyboard inactivity requirement of the STFP protocol. In some cases, the bypass mechanism is an SSHPASS mechanism.

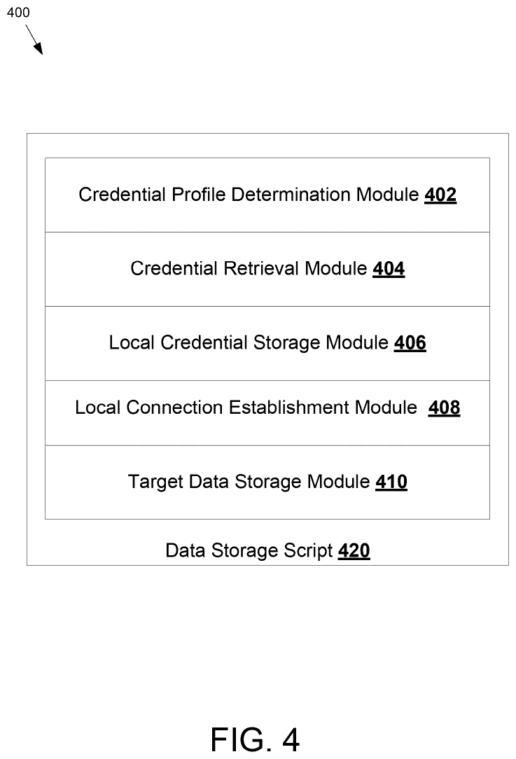

In accordance with some of the techniques described herein, to use the retrieved credential data to establish the authenticated connection to the local storage platform 120, the data storage script 118 stores the retrieved credential data as a local variable of the data storage script 118 that is not provided to any process except for the process that is executing the data storage script 118. In some cases, the data storage script is executed by a root process of the application server 112. Exemplary structures for a data storage script 118 as well as exemplary techniques for executing a data storage script 118 are described in greater detail below with reference to FIGS. 4 and 5 respectively.

FIG. 3 provides an operational example of a structure 300 for an example data retrieval script 320. As depicted in FIG. 3, the data retrieval script 320 includes a credential profile determination module 302 that is configured to determine a credential profile for a first data retrieval request from a first user. The credential profile represents one or more features of the first data retrieval request and/or the first user that are used to retrieve request-specific and/or user-specific credential data from the credential data management server 116.

In some cases, the credential profile may represent a client identifier associated with the first user and/or an application identifier associated with a software application that was used to generate the first data retrieval request based on one or more actions of the user. For example, the credential data may represent that the first data retrieval request is associated with a user in Company A and was generated after the user requested retrieval of target data using an accounting software application (e.g., an accounting software executing on the client system or on the application server 112).

As further depicted in FIG. 3, the data retrieval script 320 includes a credential retrieval module 304 that is configured to retrieve credential data needed for establishing an authenticated connection with the cloud storage platform 104 from the credential data management server 116. The credential retrieval module 304 may be configured to provide a request for retrieval of credential data needed for establishing the connection with the cloud storage platform 104 to the credential data management server 116 and receive the requested credential data in response to the request. The request for credential data may include the credential profile for the first data retrieval request as determined by the credential profile determination module 302. The credential profile determination module 302 may then be configured to, in response to the request, retrieve credential data associated with the cloud storage platform 104 and the credential profile, and provide the retrieved credential data to the application server 112.

As further depicted in FIG. 3, the data retrieval script 320 includes a local credential storage module 306 that is configured to store the credential data retrieved by the credential retrieval module 304 as a local variable (or other field) of the data retrieval script. In some cases, storing the credential data as a local variable of the data retrieval script 320 prevents any processes other than the process that executes the data retrieval script 320 from accessing the credential data directly. In some cases, by storing the retrieved credential data using a local variable, the credential storage module 306 enables authenticated data retrieval and/or storage using an authenticated connection that is established using masked credential data while the user that requests data retrieval and/or storage is granted user-level (as opposed to administrator-level) access to an application server.

In some cases, the data retrieval script 320 is executed by a root process of the application server 112 that is only accessible to non-administrator users of the application server 112. In some cases, because the data retrieval script 320 is executed by a root process of the application server 112, storing the credential data as a local variable of the data retrieval script 320 prevents any non-administrator users from directly accessing the credential data. In some cases, storing the credential data as a local variable of the data retrieval script 320 prevents display of the credential data on a command line interface if the data retrieval script 320 is executed using a command provided by the command line interface.

As further depicted in FIG. 3, the data retrieval script 320 includes a remote connection establishment module 308 that is configured to establish an authenticated connection with the cloud storage platform 104 using the local variable storing the credential data. In some cases, the local variable is an input parameter of a routine corresponding to the remote connection establishment module 308. In some cases, the remote connection establishment module 308 provides an application programming interface (API) call to the cloud storage platform 104 that includes the local variable and/or an encrypted encoding of the local variable as a parameter of the API call.

As further depicted in FIG. 3, the data retrieval script 320 includes a target data retrieval module 310 that is configured to retrieve target data from the cloud storage platform 104 using the authenticated connection established by the remote connection establishment module 308. In some cases, the target data retrieval module 310 makes a GET-request-type API call to a database API of the cloud storage platform 104. In some cases, subsequent to retrieving all of the target data, the target data retrieval module 310 terminates the authenticated connection established by the remote connection establishment module 308.

FIG. 4 provides an operational example of a structure 400 for an example data storage script 420. As depicted in FIG. 4, the data storage script 420 includes a credential profile determination module 402 that is configured to determine a credential profile for a first data storage request from a first user.

In some cases, the credential profile represents one or more features of the first data storage request and/or the first user that are used to retrieve request-specific and/or user-specific credential data from the credential data management server 116. In some cases, the credential profile may represent a client identifier associated with the first user and/or an application identifier associated with a software application that was used by the user to generate the first data storage request based on one or more actions of the user.

For example, the credential data may represent that the first data storage request is associated with a user in Company A and was generated after the user requested storage of target data using an accounting software application (e.g., an accounting software executing on the client system or on the application server 112). In some cases, the data storage request is part of a data retrieval request. For example, the data storage request may request storage of data retrieved using a data retrieval request. In some cases, the data storage request is independent of a data retrieval request. For example, the data storage request may request storage of data generated using a data processing routine.

As further depicted in FIG. 4, the data storage script 420 includes a credential retrieval module 404 that is configured to retrieve credential data needed for establishing an authenticated connection with the local storage platform 120 from the credential data management server 116. In some cases, the credential retrieval module 404 is configured to provide a request for retrieval of credential data needed for establishing the connection with the local storage platform 120 to the credential data management server 116 and receive the requested credential data in response to the request. In some cases, the request for credential data includes the credential profile for the first data storage request as determined by the credential profile determination module 402. In some cases, the credential profile determination module 402 is configured to, in response to the request, retrieve credential data associated with the local storage platform 120 and the credential profile, and provide the retrieved credential data to the application server 112.

As further depicted in FIG. 4, the data storage script 420 includes a local credential retrieval module 406 that is configured to store the credential data retrieved by the credential retrieval module 404 as a local variable (or other field) of the data storage script 420. In some cases, storing the credential data as a local variable of the data storage script 420 prevents any processes other than the process that executes the data storage script 420 from accessing the credential data directly.

In some cases, the data storage script 420 is executed by a root process of the application server 112 that is only accessible to non-administrator users of the application server 112. In some cases, because the data storage script 420 is executed by a root process of the application server 112, storing the credential data as a local variable of the data storage script 420 prevents any non-administrator users from directly accessing the credential data. In some cases, storing the credential data as a local variable of the data storage script 420 prevents display of the credential data on a command line interface if the data storage script 420 is executed using a command provided by the command line interface.

As further depicted in FIG. 4, the data storage script 420 includes a remote connection establishment module 408 that is configured to establish an authenticated connection with the local storage platform 120 using the local variable storing the credential data. In some cases, the local variable is an input parameter of a routine corresponding to the remote connection establishment module 408. In some cases, the remote connection establishment module 408 provides an API call to the local storage platform 120 that includes the local variable and/or an encrypted encoding of the local variable as a parameter of the API call.

As further depicted in FIG. 4, the data storage script 420 includes a target data storage module 410 that is configured to store target data on the local storage platform 120 using the authenticated connection established by the remote connection establishment module 408. In some cases, the target data storage module 410 makes a PUT-request-type API call to a database API of the local storage platform 120. In some cases, subsequent to storing all of the target data, the target data storage module 410 terminates the authenticated connection established by the remote connection establishment module 408.

FIG. 5 provides an operational example of a process 500 for executing a data retrieval script 114 or a data storage script 118. The process 500 may be performed by any of the processors provided herein. However, for discussion purposes only, steps of the process 500 are described as being performed by a client system 530 and the application server 112.

As depicted in FIG. 5, a client system 530 used by a user that has been granted user-level access to the application server 520 provides a data retrieval/storage request 506 to non-root process A 504A which is one of the N non-root processes 504A-504N of the application server 520.

As further depicted in FIG. 5, after receiving the data retrieval/storage request 506, the non-root process A 504A of the application server 112 provides a script execution request 508 to the root process 502 of the application server 112. The script execution request 508 may be a request that the root process 502 executes a data retrieval script or a data storage script.

In some cases, if the client system 530 provides a data retrieval request to a non-root process, the non-root process requests that the root process 502 executes a data retrieval script. In some cases, if the client system 530 provides a data storage request to a non-root process, the non-root process requests that the root process 502 executes a data storage script.

In some cases, if the non-root process requests that the root process 502 executes a data retrieval script, the root process 502 executes the data retrieval request in response to the request received from the non-root process. In some cases, if the non-root process requests that the root process 502 executes a data storage script, the root process 502 executes the data storage request in response to the request received from the non-root process.

FIG. 6 provides an operational example of an organizational structure 600 for a credential data management server 620. As depicted in FIG. 6, the credential data management server 620 stores particular credential data for each combination of an application identifier, a client/user identifier, and a target storage platform.

For example, as depicted in FIG. 6, credential data 602 is provided in response to requests for credential data of the cloud storage platform 104 that originate from the application identifier App1 and the client/user identifier User1. As another example, as depicted in FIG. 6, credential data 604 is provided in response to requests for credential data of the local storage platform 120 that originate from the application identifier App1 and the client/user identifier User1. As an additional example, as depicted in FIG. 6, credential data 606 is provided in response to requests for credential data of the cloud storage platform 104 that originate from the application identifier App1 and the client/user identifier User2. As yet another example, as depicted in FIG. 6, credential data 608 is provided in response to requests for credential data of the local storage platform 120 that originate from the application identifier App1 and the client/user identifier User2. As a further example, as depicted in FIG. 6, credential data 610 is provided in response to requests for credential data of the cloud storage platform 104 that originate from the application identifier App2 and the client/user identifier User1. As yet another example, as depicted in FIG. 6, credential data 612 is provided in response to requests for credential data of the local storage platform 120 that originate from the application identifier App2 and the client/user identifier User1.

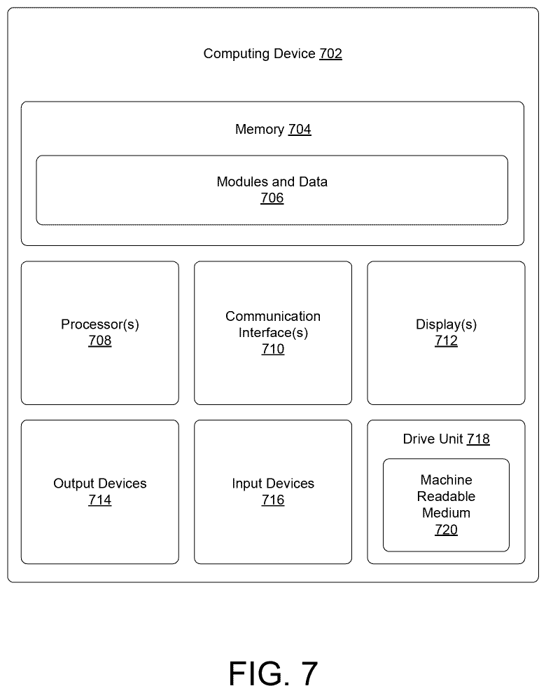

FIG. 7 shows an example system architecture for a computing device 702 associated with the architecture 100 described herein. A computing device 702 can be a server, computer, or other type of computing device that executes at least a portion of the architecture 100. In some examples, elements of the architecture 100 can be distributed among, and/or be executed by, multiple computing devices 702.

A computing device 702 can include memory 704. In various examples, the memory 704 can include system memory, which may be volatile (such as RAM), non-volatile (such as ROM, flash memory, etc.) or some combination of the two. The memory 704 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 702 associated with the architecture 100. Any such non-transitory computer-readable media may be part of the computing devices 702. The memory 704 can include modules and data 706 needed to perform operations of one or more computing devices 702 of the architecture 100.

One or more computing devices 702 of the architecture 100 can also have processor(s) 708, communication interfaces 710, displays 712, output devices 714, input devices 716, and/or a drive unit 718 including a machine readable medium 720.

In various examples, the processor(s) 708 can be a central processing unit (CPU), a graphics processing unit (GPU), both a CPU and a GPU, or any other type of processing unit. Each of the one or more processor(s) 708 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 708 may also be responsible for executing computer applications stored in the memory 704, which can be associated with common types of volatile (RAM) and/or nonvolatile (ROM) memory.

The communication interfaces 710 can include transceivers, modems, interfaces, antennas, telephone connections, and/or other components that can transmit and/or receive data over networks, telephone lines, or other connections.

The display 712 can be a liquid crystal display or any other type of display commonly used in computing devices. For example, a display 712 may be a touch-sensitive display screen, and can then also act as an input device or keypad, such as for providing a soft-key keyboard, navigation buttons, or any other type of input.

The output devices 714 can include any sort of output devices known in the art, such as a display 712, speakers, a vibrating mechanism, and/or a tactile feedback mechanism. Output devices 714 can also include ports for one or more peripheral devices, such as headphones, peripheral speakers, and/or a peripheral display.

The input devices 716 can include any sort of input devices known in the art. For example, input devices 716 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 720 can store one or more sets of instructions, such as software or firmware, that embodies any one or more of the methodologies or functions described herein. The instructions can also reside, completely or at least partially, within the memory 704, processor(s) 708, and/or communication interface(s) 710 during execution thereof by the one or more computing devices 702 of the architecture 100. The memory 704 and the processor(s) 708 also can constitute machine readable media 720.

Accordingly, to enable data retrieval or storage using masked credential data while granting user-level access to the requesting user, an application server 112 performs operations that enable: (i) storing credential data in a credential data management server that is separate from the application server, (ii) executing a data retrieval script or a data storage script using a root process of the application server that is not accessible by a user that is given user-level access to the application server, and (iii) storing credential data retrieved from a credential data management server as a local variable of a data retrieval script or a data storage script. Each of the noted capabilities adds a layer of protection to data retrieval or storage operations. For example, storing credential data on a credential data management server that is separate from an application server on which a user of the application system has user-level access privileges provides a first layer of protection against direct access to the credential data by unauthorized users (e.g., by non-administrator users of the application server that do not have access to a root process of the application server). As another example, requiring that a successful request for retrieval of credential data is provided using a data retrieval or storage script that is executed by a root process of the application server provides a second layer of protection against direct access to the credential data by unauthorized users (e.g., by non-administrator users of the application server that do not have access to a root process of the application server). As a further example, storing credential data retrieved using a data retrieval or storage script in a local variable of the script provides a third layer of protection against direct access to the credential data by unauthorized users (e.g., by non-administrator users of the application server that do not have access to a root process of the application server). Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
receiving, by a processor of an application server and from a client device, a data retrieval request associated with accessing target data stored on a cloud storage platform;
providing, by the processor, a credential data request associated with the data retrieval request and the cloud storage platform to a credential data management server;
based on the credential data request, receiving, by the processor, credential data from the credential data management server;
storing, by the processor, the credential data in a field of a data retrieval script; and
executing, by the processor, the data retrieval script based on the field, wherein executing the data retrieval script comprises:
establishing an authenticated connection between the processor and the cloud storage platform, and
accessing the target data using the authenticated connection.

2. The computer-implemented method of claim 1, wherein the field is a local variable of the data retrieval script.

3. The computer-implemented method of claim 1, wherein the data retrieval script is executed by a root process of the application server.

4. The computer-implemented method of claim 3, wherein the data retrieval request is received by a non-root process of the application server.

5. The computer-implemented method of claim 4, wherein the credential data management server is configured to retrieve the credential data based on an application identifier associated with the non-root process.

6. The computer-implemented method of claim 1, wherein the credential data management server is configured to retrieve the credential data based on a client identifier associated with the data retrieval request.

7. The computer-implemented method of claim 1, further comprising:
receiving, by the processor and from the client device, a data storage request associated with storing the target data in a local storage platform, wherein the local storage platform comprises a component of an application system, and the application system also comprises the application server;
providing, by the processor, an additional credential data request associated with the data storage request and the local storage platform to the credential data management server;
based on the additional credential data request, receiving, by the processor, additional credential data from the credential data management server;
storing, by the processor, the additional credential data in a field of a data storage script; and
executing, by the processor, the data storage script based on the field of the data storage script, wherein executing the data storage script comprises establishing an additional authenticated connection with the local storage platform and storing the target data using the additional authenticated connection.

8. The computer-implemented method of claim 7, wherein the additional authenticated connection is established using a Secure Shell File Transfer Protocol (SFTP) protocol.

9. The computer-implemented method of claim 8, wherein establishing the additional authenticated connection comprises providing the field of the data storage script using a bypass mechanism for a keyboard inactivity requirement of the STFP protocol.

10. The computer-implemented method of claim 9, wherein the bypass mechanism is an SSHPASS mechanism.

11. The computer-implemented method of claim 7, wherein the application system further comprises the credential data management server and the cloud storage platform is outside of the application system.

12. A computing system, comprising:
a processor; and
memory storing computer-executable instructions that, when executed by the processor, cause the computing system to perform operations comprising:
receiving, by the processor of an application server and from a client device, a data retrieval request associated with accessing target data stored on a cloud storage platform;
providing, by the processor, a credential data request associated with the data retrieval request and the cloud storage platform to a credential data management server;
based on the credential data request, receiving, by the processor, credential data from the credential data management server;
storing, by the processor, the credential data in a field of a data retrieval script; and
executing, by the processor, the data retrieval script based on the field, wherein executing the data retrieval script comprises establishing an authenticated connection with the cloud storage platform and accessing the target data using the authenticated connection.

13. The computing system of claim 12, wherein the field is a local variable of the data retrieval script.

14. The computing system of claim 13, wherein the data retrieval script is executed by a root process of the application server.

15. The computing system of claim 14, wherein the data retrieval request is received by a non-root process of the application server.

16. The computing system of claim 15, wherein the credential data management server is configured to retrieve the credential data based on an application identifier associated with the non-root process.

17. The computing system of claim 12, wherein the credential data management server is configured to retrieve the credential data based on a client identifier associated with the data retrieval request.

18. The computing system of claim 12, the operations further comprising:
receiving, by the processor and from the client device, a data storage request associated with storing the target data in a local storage platform, wherein the local storage platform comprises a component of an application system, and the application system also comprises the application server;
providing, by the processor, an additional credential data request associated with the data storage request and the local storage platform to the credential data management server;
based on the additional credential data request, receiving, by the processor, additional credential data from the credential data management server;
storing, by the processor, the additional credential data in a field of a data storage script; and
executing, by the processor, the data storage script based on the field of the data storage script, wherein executing the data storage script comprises establishing an additional authenticated connection with the local storage platform and storing the target data using the additional authenticated connection.

19. One or more non-transitory computer-readable media storing computer-executable instructions that, when executed by a processor, cause the processor to perform operations, comprising:
receiving, by the processor of an application server and from a client device, a data retrieval request associated with accessing target data stored on a cloud storage platform;
providing, by the processor, a credential data request associated with the data retrieval request and the cloud storage platform to a credential data management server;
based on the credential data request, receiving, by the processor, credential data from the credential data management server;
storing, by the processor, the credential data in a field of a data retrieval script; and
executing, by the processor, the data retrieval script based on the field, wherein executing the data retrieval script comprises establishing an authenticated connection with the cloud storage platform and accessing the target data using the authenticated connection.

20. The one or more non-transitory computer-readable media of claim 19, the operations further comprising:
receiving, by the processor and from the client device, a data storage request associated with storing the target data in a local storage platform, wherein the local storage platform comprises a component of an application system, and the application system also comprises the application server;
providing, by the processor, an additional credential data request associated with the data storage request and the local storage platform to the credential data management server;
based on the additional credential data request, receiving, by the processor, additional credential data from the credential data management server;
storing, by the processor, the additional credential data in a field of a data storage script;
executing, by the processor, the data storage script based on the field of the data storage script, wherein executing the data storage script comprises establishing an additional authenticated connection with the local storage platform and storing the target data using the additional authenticated connection.
